(19) United States
(12) Patent Application Publication
(10) Pub. No.: US 2019/0249778 A1
(43) Pub. Date: Aug. 15, 2019

(54) Reduced-Pressure Type Backflow Preventer

(71) Applicant: GUANGDONG YONGQUAN VALVE TECHNOLOGY CO., LTD, Foshan (CN)

(72) Inventors: Dawen Huo, Foshan (CN); Bomin Wu, Foshan (CN); Jianlin Liang, Foshan (CN); Jianming Chen, Foshan (CN); Guohao He, Foshan (CN); Biao Li, Foshan (CN); Qingxiang Pan, Foshan (CN); Mingliang Huang, Foshan (CN); Jiaxian Ou, Foshan (CN)

(21) Appl. No.: 16/335,247

(22) PCT Filed: Dec. 27, 2017
(86) PCT No.: PCT/CN2017/118999

§ 371 Date: Mar. 21, 2019

(30) Foreign Application Priority Data
Feb. 6, 2017 (CN) 201710066249.6

(51) Int. Cl. F16K 1/20; F16K 1/42; F16K 1/52; F16K 11/10; F16K 15/03

(52) U.S. Cl. CPC F16K 1/2007; F16K 1/205; F16K 15/033; F16K 1/523; F16K 11/105; F16K 1/42

(57) ABSTRACT

Disclosed is a reduced-pressure type backflow preventer comprising a valve body (1), two check valves (2) of the same structure and a drain valve:(3) wherein a cavity is formed body, and a valve wall of the valve body is provided With a water inlet, a water outlet, and a drain opening; the two check valves are both fixedly mounted inside the valve body supporting member (4), and are positioned at the water inlet and the water outlet, respectively; the drain valve is mounted outside the valve body, and is positioned at the drain opening; the check valve comprises a valve seat (201), a valve clack (202), a rocking bar (203), and a twin torsional spring (204); one side of the valve clack is hinged to an upper end of the valve seat, and the other side is provided with a roller (205); the rocking bar is connected to a lower end of the valve seat via a pin (206); the roller abuts against the rocking bar and slides on the rocking bar; the twin torsional spring is sheathed over the pin; and a spring force of the twin torsional spring acts on the rocking bar to maintain the valve clack in a normally closed state, and an external force is used to cause the roller on the valve clack to roll on the rocking bar so as to open the valve clack. The preventer provides a better flow preventing effect by virtue of the structure of the twin torsional spring and the rocking bar of the check valve.

### TECHNICAL FIELD

The present invention relates to the technical field of pipeline valves, and more particularly to a reduced-pressure type backflow preventer.

### BACKGROUND ART

A backflow preventer is used for a pipeline for sewage treatment and other pipelines to prevent backflow pollution caused by backflow of liquid in the flow direction. The backflow preventer is a valve device formed by two separate check valves and one safety drain valve. The structure of the existing check valve is so simple that the resistance to water flow is very obvious. The resistance of the check valve to the water flow increases linearly as the opening degree of the valve clack increases, and the safety drain valve frequently drains water pressure cavities of the backflow preventer generate less pressure fluctuations.

In addition, the valve seat of the domestic check valve basically adopts a metal material, and the fixed connection between components must be implemented by a traditional mechanical connection, such as threaded connection. The valve seat must be drilled and tapped, and then the components are fixedly mounted in the valve seat by means of threaded connection, which consumes time and materials.

Moreover, in the opening and closing process of the check valve, the components and the valve seat repeatedly vibrate, and the components are prone to loosening.

### SUMMARY OF THE INVENTION

The technical problem to be solved by the present invention is to provide a reduced-pressure type backflow preventer for solving the above-mentioned defects in the prior art.

To solve the technical problems mentioned above, the present invention adopts the following technical solutions: provided is a reduced-pressure type backflow preventer, comprising a valve body, two check valves of the same structure, and a drain valve, wherein a cavity is formed inside the valve body, and a valve wall of the valve body is provided with a water inlet, water outlet, and drain opening; the two check valves are both fixedly mounted inside the valve body via a supporting member, and are positioned at the water inlet and the wafer outlet, respectively; the drain is mounted outside the valve body, and is positioned at the drain opening; the check valve comprises a valve seat; a valve clack, a rocking bar and a twin torsional spring; one side of the valve clack is hinged to an upper end of the valve seat, and the other side is provided with a roller; one end of the rocking bar is a fixed end, and the other end is a free end, the fixed end of the rocking bar being connected to a lower end of the valve seat via a pin; the roller abuts against the rocking bar and slides between the fixed end of the rocking bar and the free end of the rocking bar; the lower end of the valve seat is provided with two limiting hooks; the twin torsional spring is sheathed over the pin, the twin torsional spring is arranged at two sides of the rocking bar in a bilaterally symmetrical manner, a middle torsional arm of the twin torsional spring is limited by the rocking bar, and a left and a right protruding torsional arm of the twin torsional spring are limited by the limiting hooks at the lower end of the valve seat; and a spring force of the twin torsional spring acts on the rocking bar to maintain the valve clack in a normally closed state, and an external force is used to cause the roller on the valve clack to roll on the rocking bar so as to open the valve clack.

Preferably, the free end of the rocking bar is provided with a back-hooked portion.

Preferably, a catching hole is formed in the free end of the rocking bar.

Preferably, the side of the valve clack that is provided with the roller is provided with a limiting groove for limiting the movement of the back-hooked portion of the rocking bar.

Preferably, the valve seat is provided with two, support sheets for fixing the valve clack, the valve clack being fixed between the two support sheets via a pivot; the valve seat is plastic, the support sheets are metallic, and the support sheets are integrally formed with the valve seat by using a plastic insert technology and the limiting hooks are metallic, and the limiting hooks are integrally formed with the valve seat by using the plastic insert technology.

Preferably, the valve clack is provided with a rubber sheet and a pressing plate, and the rubber sheet is fixed to the valve clack via bolts on the pressing plate.

Preferably, bosses for fixedly mounting the supporting member extend outwards from the left and right sides of the valve seat, and fixing nuts are provided on the bosses; the supporting member is connected to a stud, and the stud is sheathed with a locknut; one end of the stud is in threaded connection with the fixing nut, and the other end of the stud is in threaded connection with the supporting member; and the supporting member allows the two check valves to be fixedly mounted in the valve body by adjusting the locknut on the stud.

Preferably, gaps are formed between bottom faces of the bosses on the left and right sides of the valve seat and an inner wall of the valve body.

Preferably, side faces of the bosses on the left and right sides of the valve seat abut against the inner wall of the valve body to prevent the check valve from rotating in the valve body.

Preferably, the fixing nut is metallic, and the fixing nut is integrally formed with the valve seat by using a plastic insert technology.

Preferably, a detachable valve cover is provided at the top of the valve body.

The reduced-pressure type backflow preventer of the present invention has the beneficial effects as follows:

(1) the check valve in the preventer has a different swing structure, which makes the check valve reach a better backflow preventing effect: on the one hand, sufficient sealing force between the valve seat and the valve clack is ensured when the valve clack is in a closed state; in the opening process of the valve clack, resistance of the check valve to the water flow continuously decreases as the opening degree of the valve clack increases; and on the other hand, whether the water flow increases or decreases, the roller of the check valve slides in the lengthwise direction of the rocking bar, and the rocking bar plays a guiding role, so that the valve clack is opened more smoothly.

(2) It is convenient to mount and detach the check valve: when the check valves are mounted, one check valve is first sheathed in the valve body positioned at the water outlet, and then the other check valve is sheathed in the valve body positioned at the water inlet. The stud is screwed in the fixing nut of the check valve positioned at the water inlet, and then by tightly screwing the locknut on the stud, the supporting member is pushed outside to a pit on the valve seat of the check valve positioned at the water outlet, so that the two check valves are fixedly mounted in the valve body to ensure that in a frequent vibration working condition of the check valves, the components are in close contact with each other and will not loosen.

When the components of the backflow preventer are detached and replaced, there is no need to detach the whole device, and it only needs to detach the valve cover and unscrew the locknut in the valve cavity, push the supporting member away from the valve seat of the check valve positioned at the water outlet, and use a flat-blade screwdriver to pry the check valve out.

(3) It is convenient to replace and clean components and on line: when components of the check valve are cleaned and replaced, an operator cannot directly pry the rocking bar away by hand as the acting force of the twits torsional spring on the rocking bar is great. Therefore, by virtue of the catching hole formed in the free end of the rocking bar, the operator can make the catching hole of the rocking bar surround a protrusion of valve body, then a force is applied clockwise to the valve seat to pry the rocking bar away, and then the back-hooked portion of the rocking bar is clamped in the limiting groove of the roller and the valve clack, thus maintaining the valve clack in a normally open state, which facilitates cleaning and replacement of the components.

(4) A plastic insert technology is adopted: A plastic insert technology is used between the plastic valve seat and metal support sheet and between the metal hook and the metal nut to realize one-step forming, there is no need to use bolt connection or any other mechanical way to fixedly mount the components on the valve seat, and the mounting is very firm, which solves the problem that the domestic valve seat is basically made of a metal material such that the fixed connection between the components consumes time and materials; and the problem that in the opening and closing process of the check valve, the components and the valve seat repeatedly vibrate and the components are prone to loosening is solved.

(5) It is convenient to mount, and detach the twin torsional spring of the check valve: A spring member of the traditional check valve is complicated to mount, and by virtue of the two limiting hooks arranged on the lower end of the valve seat, it only needs to sheath the twin torsional spring over the pin, and then a screwdriver is used to respectively pry a left and a right protruding torsional arm of the twin torsional spring to the respective limiting hooks, this hooking method facilitating the installation and detachment of the spring.

### BRIEF DESCRIPTION OF THE DRAWINGS

The present invention will be further explained below in conjunction with the accompanying drawings and embodiments. In the accompanying drawings:

FIG. 1 is a structural schematic diagram of a reduced-pressure type backflow preventer of a preferred embodiment of the present invention and other pipelines;

FIG. 2 is a cross-sectional view of FIG. 1;

FIG. 3 is a structural schematic diagram of a reduced-pressure type backflow preventer of a preferred embodiment of the present invention;

FIG. 4 is an enlarged schematic top view showing the area A in FIG. 3;

FIG. 5 is an enlarged schematic top view showing the area B in FIG. 3;

FIG. 6 is a structural schematic diagram of a check valve and a supporting member;

FIG. 7 is an enlarged schematic diagram of the area C in FIG. 6;

FIG. 8 is an enlarged schematic diagram showing the area D in FIG. 6;

FIG. 9 is an enlarged schematic diagram showing the area E in FIG. 6;

FIG. 10 is a structural schematic diagram of a check valve in a preferred embodiment of the present invention in a closed state;

FIG. 11 is a structural schematic diagram of a check valve in a preferred embodiment of the present invention in a half-open state;

FIG. 12 is a structural schematic diagram of a check valve in a preferred embodiment of the present invention in a maximally open state;

FIG. 13 is a structural schematic diagram of a check valve in a preferred embodiment of the present invention in an open limit state;

FIG. 14 is a schematic diagram showing the operation of cleaning and replacing components of the check valve in the present invention;

In the figures, 1. Valve body; 101. Protrusion; 102. Valve cover; 2. Check valve; 201. Valve seat; 2011. Boss; 2012. Pit; 202. Valve clack; 2021. Limiting groove; 203. Rocking bar; 2031. Back-hooked portion; 2032. Catching hole; 204. Twin torsional spring; 205. Roller; 206. Pin; 207. Limiting hook; 208. Rubber sheet; 209. Pressing plate: 210. Support sheet; 3. Drain valve: 4. Supporting member; 5. Fixing nut; 6. Stud; 7. Locknut; 8. Gap.

### DETAILED DESCRIPTION OF EMBODIMENTS

Hereinafter, further description is made to the present invention in combination with the accompany drawings and the detailed description.

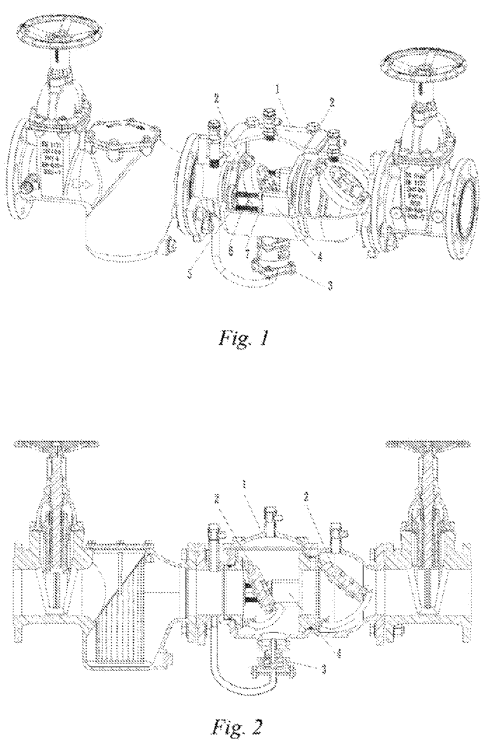

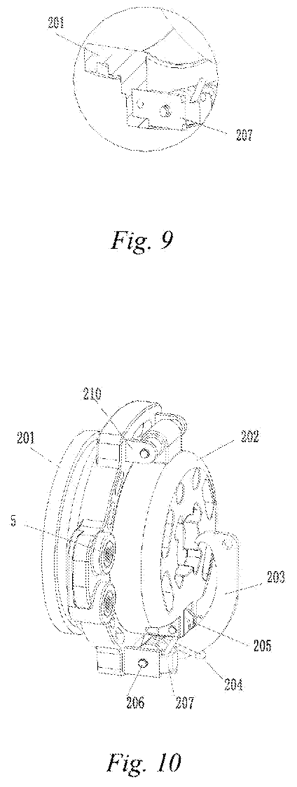

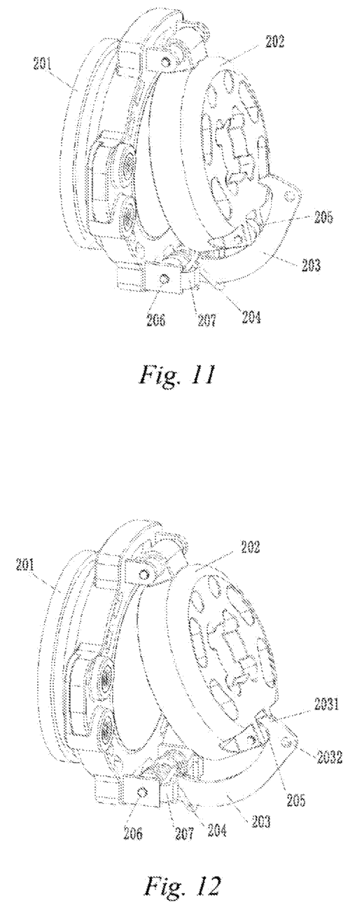

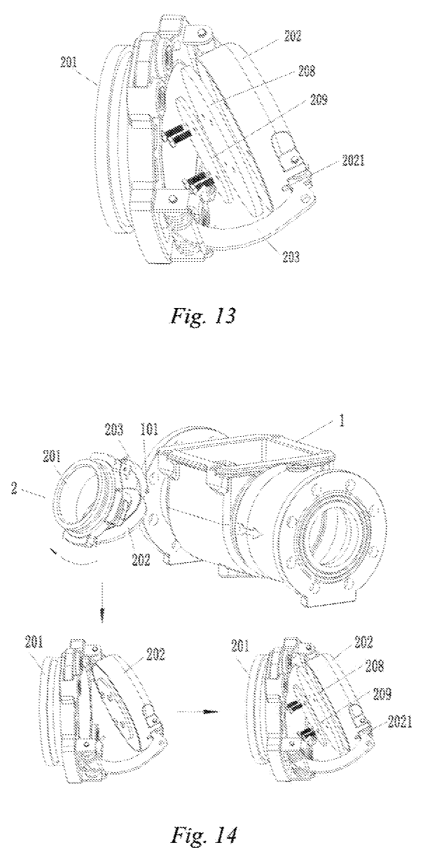

As shown in FIGS. 1-14, disclosed is a reduced-pressure type backflow preventer, comprising a valve body 1, two check valves 2 of the same structure, and a drain valve 3, wherein a cavity is formed inside the valve body, and a valve wall of the valve body is provided with a water inlet, a water outlet, and a drain opening; the two check valves are both fixedly mounted inside the valve body via a supporting member 4, and are positioned at the water inlet and the water outlet, respectively; the drain valve is mounted outside the valve body, and is positioned at the drain opening;

the check valve 2 comprises a valve seat 201, a valve clack 202, a rocking bar 203, and a twin torsional spring 204; one side of the valve clack is hinged to an upper end of the valve seat, and the other side of the valve clack is provided with a roller 205; one end of the rocking bar is a fixed end, and the other end is a free end, the fixed end of the rocking bar being connected to a lower end of the valve seat via a pin 206; the roller abuts against the rocking bar and slides between the fixed end of the rocking bar and the free end of the rocking bar; the lower end of the valve seat is provided with two limiting hooks 207; the twin torsional spring is sheathed over the pin the twin torsional spring is arranged at two sides of the rocking bar in a bilaterally symmetrical manner, a middle torsional arm of the twin torsional spring is limited by the rocking bar, and a left and a right protruding torsional arm of the twin torsional spring are limited by the limiting hooks at the lower end of the valve seat and a spring force of the twin torsional spring acts on the rocking bar to maintain the valve clack in a normally closed state, and an external force is used to cause the roller on the valve clack to roll on the rocking bar so as to open the valve clack. Two check valves are provided, with the elastic force of the twin torsional spring of the check valve positioned at the water outlet being greater than that of the check valve positioned at the water inlet.

As shown in FIGS. 1 and 2, the working process of the reduced-pressure type backflow preventer of the present invention is as follows:

water flow flows from left to right, thrusts aside two valves and passes through the reduced-pressure type backflow preventer of the present invention. When water flow is unlikely to flow back, the valve clacks of the two check valves are closed to prevent backflow, and liquid in the cavity of the valve body flows away from the drain valve below. The drain valve is provided with a spring. In a normal working condition, the spring closes the pressure relief valve, and when backflow occurs the cavity, the drain valve is opened, and liquid flows away from below.

As a preferred solution, the free end of the rocking bar is provided with a back-hooked portion 2031. When the valve clack is opened to a limit position, the back-hooked portion is used to clamp the roller, so that the valve clack cannot be further opened, thus achieving a limiting effect

As shown in FIGS. 10-13, when the valve clack is in a closed state, a spring force of the twin torsional spring acts on the rocking bar, so that the roller of the valve clack is pressed on the rocking bar, thus ensuring sufficient sealing force between the valve seat and the valve clack when the valve clack is in the closed state; when water flow increases, the opening degree of the valve clack increases, thus the roller on the valve clack slides from the fixed end of the rocking bar to the free end of the rocking bar, the contact point of the rocking bar and the roller continuously changes as the opening degree of the valve clack increases, and the arm of the acting force of the rocking bar to the valve clack continuously increases, so that in the opening process of the valve clack, the resistance of the valve clack to water flow continuously decreases; and when the valve clack is opened to a limit position, the back-hooked portion of the rocking bar clamps the roller, so that the valve clack cannot be further opened.

The first advantage of the reduced-pressure type backflow preventer of the present invention is a different swing structure in the check valve which makes the preventer reach a better backflow preventing effect on the one hand, by virtue of the structure of interaction of the twin torsional spring and the rocking bar, sufficient sealing force between the valve seat and the valve clack is ensured when the valve clack is in a closed state; in the opening process of the valve clack, resistance of the check valve to the water flow continuously decreases as the opening degree of the valve clack increases; and on the other hand, whether the water flow increases or decreases, the roller of the check valve slides in the lengthwise direction of the rocking bar, and the rocking bar plays a guiding role, so that the valve clack is opened more smoothly.

The second advantage of the reduced-pressure type backflow preventer of the present invention is the convenience of installation and detachment of the check valve.

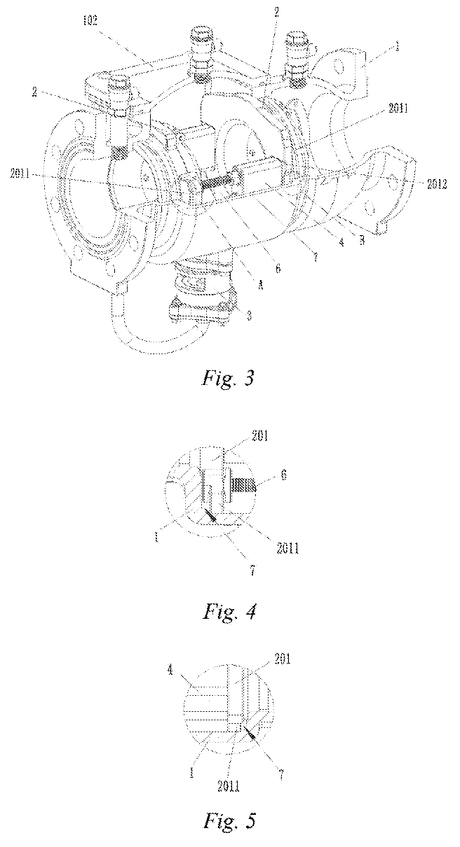

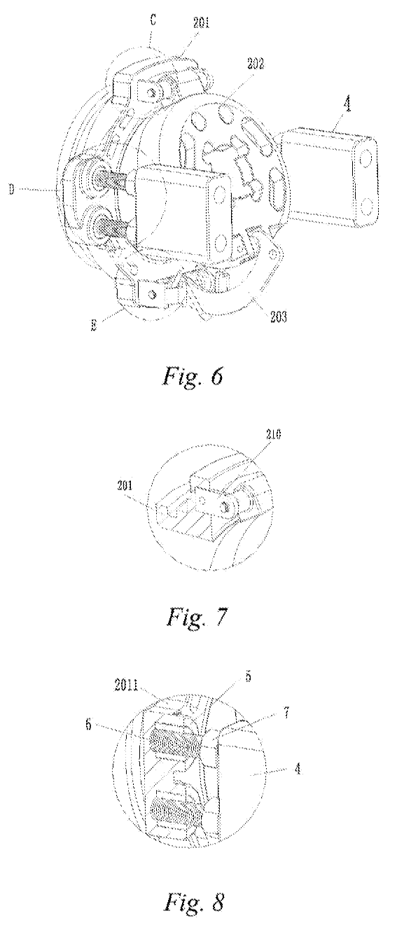

As shown in FIGS. 3 and 6, in order to firmly mount the two check valves in the valve body, bosses 2011 for fixedly mounting the supporting member extend outwards from the left and right sides of the valve seat of each cheek valve, and two fixing nuts 5 are provided on each boss; two supporting members are provided in the present invention, each supporting member is connected to a stud 6, and the stud is sheathed with a locknut 7; an internal thread is provided in the supporting member, one end of the stud is in threaded connection with the fixing nut, and the other end of the stud is in threaded connection with the supporting member; and the supporting member allows the two check valves to be fixedly mounted in the valve body by adjusting the locknut on the stud. The side faces of the bosses are in contact with the inner wall of the valve body, so that the check valve cannot swing left and right.

As a further preferred solution, certain gaps 8 are formed between the bottom faces of the bosses on the left and right sides of the valve seat and the inner wall of the valve body, which is convenient for workers, when detaching the check valve, to pry the whole check valve out by inserting a flat-blade screwdriver into the gaps, thus the detachment is convenient, as shown in FIGS. 4 and 5.

A detachable vale cover is provided at the top of the valve body 102.

The installation and detachment process of the check valve in the present invention is as follows:

when the check valves are mounted, one check valve is first sheathed in the valve body positioned at the water outlet, and then the other check valve is sheathed in the valve body positioned at the water inlet. The stud is screwed in the fixing nut of the check valve positioned at the water inlet, and then by tightly screwing the locknut on the stud, the supporting member is pushed outside to a pit 2012 on the valve seat of the check valve positioned at the water outlet, so that the two check valves are fixedly mounted in the valve body to ensure that in a frequent vibration working condition of the check valves, the components are in close contact with each other and will not loosen.

When the components of the backflow preventer are detached and replaced, there is no need to detach the whole device, and it only needs to detach the valve cover and unscrew the locknut in the valve cavity, push the supporting member away from the valve seat of the check valve positioned at the water outlet, and use a flat-blade screwdriver to pry the check valve out.

The third advantage of the reduced-pressure type backflow preventer of the present invention is the convenient on-line replacement and cleaning of the components:

A catching hole 2032 is formed in the free end of the rocking bar of the check valve. The side of the valve clack that is provided with the roller is provided with a limiting groove 2021 for limiting the movement of the back-hooked portion of the rocking bar. When components of the check valve in the preventer are cleaned and replaced, an operator cannot directly pry the rocking bar away by hand as the acting force of the twin torsional spring on the rocking bar is great. Therefore, as shown in FIG. 14 by virtue of the catching hole formed in the free end of the rocking bar, the operator can make the catching hole of the rocking bar surround a protrusion (the protrusion 101 can be arranged on the valve body 1, and can also be arranged on a convenient position for cleaning), then a force is applied clockwise to the valve seat to pry the rocking bar away, and then the back-hooked portion of the rocking bar is clamped in the hunting groove of the roller and the valve clack, thus maintaining the valve clack in a normally open state, which facilitates the cleaning and replacement of the components. The valve clack is provided with a rubber sheet 208 and a pressing plate 209, and the rubber sheet is fixed to the valve clack via bolts on the pressing plate. The rubber sheet of the check valve is generally prone to wear. When replacing the rubber sheet, the worker directly twists the bolt on the pressing plate and replaces the rubber sheet.

Furthermore, the twin torsional spring of the check valve of the present invention is convenient to mount, while a spring member of the traditional check valve is complicated to mount, and by virtue of the two limiting hooks arranged on the lower end of the valve seat, it only needs to sheath the twin torsional spring over the pin, and then a screwdriver is used to respectively pry a left and a right protruding torsional arm of the twin torsional spring to the respective limiting hooks, this hooking method facilitating the installation and detachment of the spring.

As shown in FIGS. 6-9, the valve seat is provided with two support sheets 210 for fixing the valve clack, the valve clack being fixed between the two support sheets via a pivot; and the valve seat is plastic, and the support sheets, the limiting hooks 207 and the fixing nuts 5 are all metallic and are integrally formed with the valve seat by using a plastic insert technology. The plastic insert technology adopted by the present invention is a processing technology known in the prior art, and obtains a better effect when applied to the check valve in the present invention.

The fourth advantage of the reduced-pressure type backflow preventer of the present invention is that a plastic insert technology is used between the plastic valve seat and metal support sheet and between the metal hook and the metal nut to realize one-step forming, there is no need to use bolt connection or any other mechanical way to fixedly mount the components on the valve seat, and the mounting is very firm, which solves the problem that the domestic valve seat is basically made of a metal material such that the fixed connection between the components consumes time and materials; and the problem that in the opening and closing process of the check valve, the components and the valve seat repeatedly vibrate and the components are prone to loosening is solved.

For those skilled in the art various other, corresponding changes and variations can be made according to the technical solutions and concepts described above, while all these changes and variations should fall within the scope of protection of the claims of the present invention.

1. A reduced-pressure type backflow preventer, characterized by comprising a valve body two check valves of the same structure and a drain valve wherein a cavity is formed inside the valve body, and a valve wall of the valve body is provided With a water inlet, a water outlet, and a drain opening; the two check valves are both fixedly mounted inside the valve body via a supporting member, and are positioned at the water inlet and the water outlet, respectively; the drain valve is mounted outside the valve body, and is positioned at the drain opening; the check valve comprises a valve seat, a valve clack, a rocking bar, and a twin torsional spring; one side of the valve clack is hinged to an upper end of the valve seat, and the other side is provided with a roller; one end of the rocking bar is a fixed end, and the other end is a free end, the fixed end of the rocking bar being connected to a lower end of the valve seat via a pin; the roller abuts against the rocking bar and slides between the fixed end of the rocking bar and the free end of the rocking bar; the lower end of the valve seat is provided with two limiting hooks; the twin torsional spring is sheathed over the pin, the twin torsional spring is arranged at two sides of the rocking bar in a bilaterally symmetrical manner, a middle torsional arm of the twin torsional spring is limited by the rocking bar, and a left and a right protruding torsional arm of the twin torsional spring are limited by the limiting hooks at the lower end of the valve seat; and a spring force of the twin torsional spring acts on the rocking bar to maintain the valve clack in a normally closed state, and an external force is used to cause the roller on the valve clack to roll on the rocking bar so as to open the valve clack.

2. The reduced-pressure type backflow preventer according to claim 1, characterized in that the free end of the rocking bar is provided with a back-hooked portion.

3. The reduced-pressure type backflow preventer according to claim 1, characterized in that a catching hole is formed in the free end of the rocking bar.

4. The reduced-pressure type backflow preventer according to claim 1, characterized in that the side of the valve clack that is provided with the roller is provided with a limiting groove for limiting the movement of the back-hooked portion of the rocking bar.

5. The reduced-pressure type backflow preventer according to claim 1, characterized in that the valve seat is provided with two support sheets for fixing the valve clack, the valve clack being fixed between the two support sheets via a pivot; the valve seat is plastic, the support sheets are metallic, and the support sheets are integrally formed with the valve seat by using a plastic insert technology; and the limiting hooks are metallic, and the limiting hooks are integrally formed with the valve seat by using the plastic insert technology.

6. The reduced-pressure type backflow preventer according to claim 1, characterized in that the valve clack is provided with a rubber sheet and a pressing plate, and the rubber sheet is fixed to the valve clack via bolts on the pressing plate.

7. The reduced-pressure type backflow preventer according to claim 1, characterized in that bosses for fixedly mounting the supporting member extend outwards from the left and right sides of the valve seat, and fixing nuts are provided on the bosses; the supporting member is connected to a stud, and the stud is sheathed with a locknut; one end of the stud is in threaded connection with the fixing nut, and the other end of the stud is in threaded connection with the supporting member; and the supporting member allows the two check valves to be fixedly mounted in the valve body by adjusting the locknut on the stud.

8. The reduced-pressure type backflow preventer according to claim 7, characterized in that gaps are formed between bottom faces of the bosses on the left and right sides of the valve seat and an inner wall of the valve body.

9. The reduced-pressure type backflow preventer according to claim 7, characterized in that side faces of the bosses on the left and right sides of the valve seat abut against the it wall of the valve body to prevent the check valve from rotating in the valve body.

10. The reduced-pressure type backflow preventer according to claim 7, characterized in that the fixing nut is metallic, and the fixing nut is integrally formed with the valve seat by using a plastic insert technology.

11. The reduced-pressure type backflow preventer according to claim 1, characterized in that a detachable valve cover is provided at the top of the valve body.
